(19) United States
(12) Patent Application Publication
(10) Pub. No.: US 2026/0362262 A1
(43) Pub. Date: Nov. 12, 2026

(54) CONTROLLING A PROCESS TOWARDS A CELL WITH A DUPLEX OPERATION

(71) Applicant: Nokia Technologies Oy, Espoo (FI)

(72) Inventors: Claudio ROSA, Randers NV (DK); Jarkko Tuomo KOSKELA, Oulu (FI); Qi LIU, Beijing (CN); Hartmut WILHELM, Ulm (DE)

(73) Assignee: Nokia Technologies Oy, Espoo (FI)

(21) Appl. No.: 19/111,987

(22) PCT Filed: Sep. 30, 2022
(86) PCT No.: PCT/CN2022/123659

§ 371 Date: Mar. 14, 2025

(51) Int. Cl. H04W 36/00; H04L 5/14; H04W 36/08

(52) U.S. Cl. CPC H04W 36/00837; H04L 5/14; H04W 36/008357; H04W 36/08

(57) ABSTRACT

Example embodiments of the present disclosure relate to controlling a process towards a cell with a duplex operation. A method comprises: receiving, at a first device from a second device, at least one of a first set of values and a second set of values for a parameter set associated with a process towards a cell; determining whether a condition associated with a duplex operation is met; and in accordance with a determination that the condition is met, at least applying the second set of values to the process towards the cell.

### FIELD

Various example embodiments of the present disclosure generally relate to the field of telecommunication and in particular, to methods, devices, apparatuses and computer readable storage medium for controlling a process towards a cell with an enhanced duplex operation.

### BACKGROUND

Currently, the new radio (NR) supports two duplexing modes: Frequency Division Duplex (FDD) for paired bands and Time Division Duplex (TDD) for unpaired bands. In TDD, the time domain resource is split between downlink (DL) and uplink (UL). Allocation of a limited time duration for the uplink in TDD would result in reduced coverage, increased latency, and reduced capacity.

To address the challenges above, a study on the evolution of duplexing operation in NR has been initiated. Subband non-overlapping full duplex (SBFD) has been proposed as a scheme of an enhanced duplex operation. In the SBFD, simultaneous DL transmission and UL reception at a NR NodeB (also referred to as a gNB) on different physical resource blocks (PRBs) within an unpaired wideband NR cell is allowed. This duplexing scheme is also referred to as cross-division duplexing (xDD) or Flexible Duplexing (FDU).

### SUMMARY

In a first aspect of the present disclosure, there is provided a first device. The first device comprises at least one processor; and at least one memory storing instructions that, when executed by the at least one processor, cause the first device at least to perform: receiving, from a second device, at least one of a first set of values or a second set of values for a parameter set associated with a process towards a cell; determining whether a condition associated with a duplex operation is met; and in accordance with a determination that the condition is met, at least applying the second set of values to the process towards the cell.

In a second aspect of the present disclosure, there is provided a second device. The second device comprises at least one processor; and at least one memory storing instructions that, when executed by the at least one processor, cause the second device at least to perform: determining whether a cell has a capability of a duplex operation; and in accordance with a determination that the cell has the capability of the duplex operation, at least transmitting, to the first device, a second set of values for a parameter set associated with a process towards the cell.

In a third aspect of the present disclosure, there is provided a method. The method comprises: receiving, at a first device from a second device, at least one of a first set of values or a second set of values for a parameter set associated with a process towards a cell; determining whether a condition associated with a duplex operation is met; and in accordance with a determination that the condition is met, at least applying the second set of values to the process towards the cell.

In a fourth aspect of the present disclosure, there is provided a method. The method comprises: determining at a second device whether a cell has a capability of a duplex operation; and in accordance with a determination that the cell has the capability of the duplex operation, at least transmitting, to the first device, a second set of values for a parameter set associated with a process towards the cell.

In a fifth aspect of the present disclosure, there is provided a first apparatus. The first apparatus comprises means for receiving, from a second apparatus, at least one of a first set of values or a second set of values for a parameter set associated with a process towards a cell; means for determining whether a condition associated with a duplex operation is met; and means for, in accordance with a determination that the condition is met, at least applying the second set of values to the process towards the cell.

In a sixth aspect of the present disclosure, there is provided a second apparatus. The second apparatus comprises means for determining whether a cell has a capability of a duplex operation; and means for, in accordance with a determination that the cell has the capability of the duplex operation, at least transmitting, to a first apparatus, a second set of values for a parameter set associated with a process towards the cell.

In a seventh aspect of the present disclosure, there is provided a computer readable medium. The computer readable medium comprises instructions stored thereon for causing an apparatus to perform at least the method according to the first aspect.

In an eighth aspect of the present disclosure, there is provided a computer readable medium. The computer readable medium comprises instructions stored thereon for causing an apparatus to perform at least the method according to the second aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart for a process towards a cell according to some example embodiments of the present disclosure;

FIG. 3 illustrates a flowchart of a method implemented at a first device according to some example embodiments of the present disclosure;

FIG. 4 illustrates a flowchart of a method implemented at a second device according to some example embodiments of the present disclosure;

FIG. 5 illustrates a simplified block diagram of a device that is suitable for implementing example embodiments of the present disclosure; and

FIG. 6 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As used herein, “a set of elements” means one or more such elements. For example, a set of values means one or more values. Similar, a parameter set may comprise one or more parameters.

As used herein, the term “enhanced duplex operation” may refer to any suitable duplexing scheme different from the traditional TDD and FDD. The enhanced duplex operation may involve simultaneous reception and transmission by a network device in unpaired frequency bands. Examples of the enhanced duplex operation may include but not be limited to SBFD, dynamic or flexible TDD. In the following, the term “enhanced duplex operation” is used for the purpose of illustration without any limitation to the protection scope. The example embodiments described herein with respect to the enhanced duplex operation may be applied to any suitable type of duplex operation.

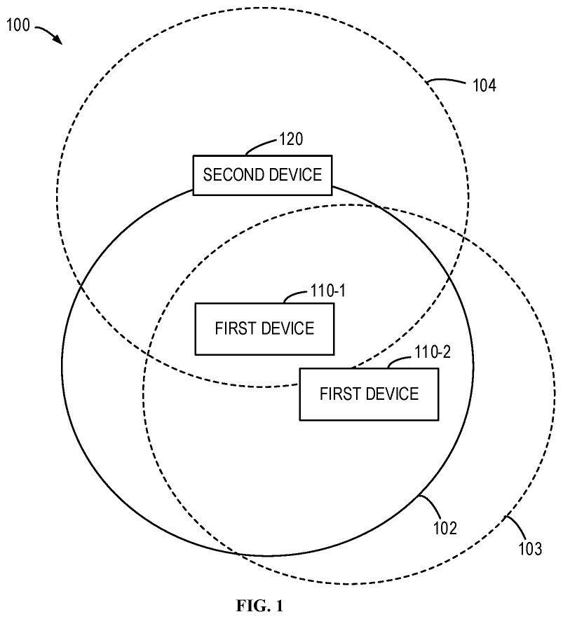

FIG. 1 illustrates an example communication environment 100 in which example embodiments of the present disclosure can be implemented. The communication environment 100 includes a first device 110-1 and a first device 110-2, which is collectively referred to as “first devices” 110 or individually referred to as “first device” 110. The first device 110 can communicate with a second device 120. A serving area of the second device 120 is called a cell. The second device 120 can serve one or more cells, for example, a cell 102. In some example embodiments, the first device 110 may include a terminal device and the second device 120 may include a network device serving the terminal device.

In the following, for the purpose of illustration, some example embodiments are described with the first device 110 operating as a terminal device and the second device 120 operating as a network device. However, in some example embodiments, operations described in connection with a terminal device may be implemented at a network device or other device, and operations described in connection with a network device may be implemented at a terminal device or other device.

In some example embodiments, if the first device 110 is a terminal device and the second device 120 is a network device, a link from the second device 120 to the first device 110 is referred to as a downlink (DL), while a link from the first device 110 to the second device 120 is referred to as an uplink (UL). In DL, the second device 120 is a transmitting (TX) device (or a transmitter) and the first device 110 is a receiving (RX) device (or a receiver). In UL, the first device 110 is a TX device (or a transmitter) and the second device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

The cell 102 has a capability of an enhanced duplex operation, or in other words, the cell 102 supports the enhanced duplex operation. In the following, a cell with the capability of the enhanced duplex operation or having the enhanced duplex operation capability may be also referred to as an ED cell. For example, the enhanced duplex operation may comprise the SBFD operation and the cell 102 is an SBFD cell accordingly. It is to be understood that the SBFD operation is an example of the enhanced duplex operation. In the example embodiments of the present disclosure, the enhanced duplex operation may comprise any suitable type of duplexing operation other than the traditional TDD operation and FDD operation. For another example, the enhanced duplex operation may comprise the dynamic TDD operation.

In some example embodiments, the environment 100 may comprise a cell 103 which does not have the enhanced duplex operation capability, or in other words, the cell 103 cannot support the enhanced duplex operation. For example, the cell 103 may not have the capability of SBFD operation. In the following, a cell without the capability of the enhanced duplex operation may be also referred to as a legacy cell. In other words, the ED cell and the legacy cell may coexist in the environment 100. However, this is an example. Alternatively, in some example embodiments, all the cells may support the enhanced duplex operation.

In some example embodiments, the environment 100 may comprise a cell 104 which is served by another device different from the second device 120. The cell 104 may be a neighboring cell.

The first device 110-1 supports the enhanced duplex operation, which may mean that the first device 110-1 is aware that the second device (for example, a network device) is capable of the enhanced duplex operation. The first device 110-1 is also referred to as an ED capable device or ED aware device. The first device 110-2 does not support the enhanced duplex operation and thus is also referred to as a legacy device. In an example, the enhanced duplex operation may comprise the SBFD operation. Accordingly, the first device 110-1 may be a SBFD aware device and the first device 110-2 may be a legacy device.

It is to be understood that the communication environment 100 is given for the purpose of illustration without any limitation to the protection scope. The communication environment 100 may include any suitable number of devices and cells configured to implementing example embodiments of the present disclosure.

Take the SBFD as an example of the enhanced duplex operation. SBFD cells are expected to coexist with legacy cells, for example, other cells supporting only traditional TDD operation from both co-channel (i.e., cells deployed on the same carrier frequency, e.g. belonging to the same operator) and adjacent channel perspective (i.e., cells deployed on an adjacent carrier, e.g. belonging to a different operator). In addition, existing UEs, which cannot be upgraded to support the SBFD-specific functionalities, may also be served on SBFD cells. It is desirable that these UEs do not experience significant performance degradation, e.g. as compared to the performance in legacy TDD cells. In other words, backwards compatibility in the SBFD cells needs to be ensured.

In another aspect, during a cell selection or cell reselection process, the UE scans and measures signals on one or more radio frequencies to select a suitable serving cell and camp on it and/or to decide whether to reselect from its current serving cell to another cell as its new serving cell. For example, the UE may measure the signal from the cell by measuring a reference signal received power (RSRP) and/or a reference signal received quality (RSRQ). One or more signal parameters of the signals received from a cell may be measured at a UE, and a cell selection (or reselection) value for the cell may be determined based on such signal parameters and one or more network configured offsets and/or reselection priorities. If the measured signal meets predetermined criteria, the UE may select and/or reselect to the corresponding cell. Selection and/or reselection criteria may be adjusted based on UE capability and whether the cell serves a particular application.

Absolute priorities of different frequencies are provided to the UE in the system information or a radio resource control (RRC) message, for example, the RRCRelease message. The UE shall perform cell reselection evaluation based on priorities of frequencies that are given in system information.

A SBFD cell can perform simultaneous DL Tx and UL Rx on non-overlapping PRBs, while UEs are still operating in half duplex (HD) mode. When a SBFD cell is serving both legacy UEs and SBFD aware UEs, to simplify gNB implementation and/or to limit the impact on the performance of legacy UEs, the SBFD cell may prefer to only schedule legacy UEs in downlink-only and uplink-only slots, while SBFD aware UEs may also be scheduled during SBFD slots.

As such, a SBFD cell may be in the situation where granting access to legacy UEs may cause the need to re-configure one or more SBFD slots as TDD (DL) slots. But the gNB may want to operate with a given number of slots configured as SBFD slots to guarantee a minimum uplink capacity and/or coverage. Also, it could happen that TDD UL resources of a cell are close to full utilization while SBFD UL resources of the cell are still partially unused.

In any of the above situations, the SBFD cell may want to prevent access from legacy devices but not from SBFD aware UEs. In other words, after SBFD is introduced, it may be desirable to prevent legacy UEs from camping on SBFD cells if there are available cells not utilizing SBFD. Therefore, it is desirable to differentiate the behaviours of the legacy UEs and the behaviours of the SBFD aware UEs with respect to a process towards the SBFD cell, for example, cell selection or cell reselection towards the SBFD cell.

In a solution, it is proposed to provide an indication to the SBFD aware UE about the duplex operation mode of a cell to facilitate the SBFD aware UE to select a SBFD cell. However, the solution cannot differentiate the behaviours of the legacy UEs and the behaviours of the SBFD aware UEs. Similar problems may occur for other types of enhanced duplex operation, for example, dynamic TDD.

According to some example embodiments of the present disclosure, there is provided a solution for controlling a process towards a cell with an enhanced duplex operation. In this solution, two different sets of values for a parameter set associated with a cell are configured. An ED aware device may apply one set of values to the process towards the cell. A legacy device may apply the other set of values to the process towards the cell.

In the example embodiments of the present disclosure, an ED aware device and a legacy device apply different sets of parameter values to a process towards an ED cell. In this way, the behaviours of the legacy device and the behaviours of the ED aware device with respect to the process towards the ED cell can be differentiated. For example, by controlling the two sets of values, the legacy device is prevented from determining the ED cell as a target cell while the ED aware device is still allowed to camp on or access the ED cell.

Example embodiments of the present disclosure will be described in detail below with reference to the accompanying drawings.

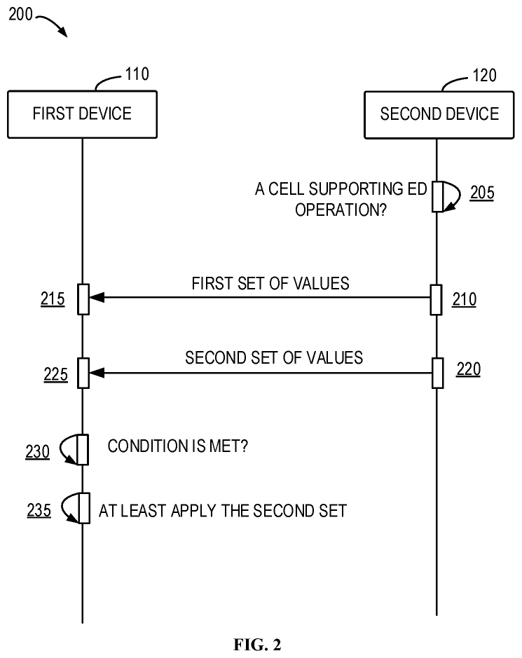

FIG. 2 shows a signaling chart 200 for controlling a process towards a cell according to some example embodiments of the present disclosure. As shown in FIG. 2, the signaling chart 200 involves a first device 110 and a second device 120. For the purpose of discussion, reference is made to FIG. 1 to describe the signaling chart 200. Although one first device 110 is illustrated in FIG. 2, it would be appreciated that there may be a plurality of first devices performing similar operations as described with respect to the first device 110 below.

In some example embodiments, the second device 120 may determine 205 whether a cell has the capability of the enhanced duplex operation. For example, in a mixed deployment scenario where a subset of the cells on a frequency layer has the capability of the SBFD, the second device 120 may determine 205 whether a specific cell is an ED cell. For another example, for each cell of a group of cells (for example, a group of neighboring cells), the second device 120 may determine 205 whether that cell is an ED cell.

It is to be understood that the cell may be a cell served by the second device 120, for example the cell 102 shown in FIG. 1. Alternatively, or in addition, the cell may be a cell served by another device, for example the cell 104 shown in FIG. 1. In such a case, the cell may be a neighboring cell.

If the second device 120 determines that the cell does not have the capability of the enhanced duplex operation, the second device 120 may transmit 210, to the first device 110, a first set of values for a parameter set. The parameter set is associated with a process towards the cell. For example, for the cell 103 which is not an ED cell, the second device 120 may transmit to the first device 110 the first set of values for the parameter set associated with a process towards the cell 103.

If the second device 120 determines that the cell has the enhanced duplex operation capability, the second device 120 may at least transmit 220, to the first device 110, a second set of values for the parameter set. For example, for the cell 102 which is an ED cell, the second device 120 may transmit to the first device 110 at least the second set of values for the parameter set associated with a process towards the cell 120. It is to be understood that the second set of values may be configured for controlling the ED aware devices' process towards the cell with the enhanced duplex operation capability.

In some example embodiments, only the second set of values may be transmitted without the first set of values. For example, if the second device 120 is aware that the first device 110 is an ED aware device, the second device 120 may transmit the second set of values without the first set of values.

Alternatively, in some example embodiments, the second device 120 may transmit both the first and second sets of values to the first device 110. For example, if the second device 120 is not aware whether the first device 110 supports the enhanced duplex operation, or if the first and second sets of values are broadcasted to a plurality of first devices which include devices supporting the ED operation and devices not supporting the ED operation, the second device 120 may transmit both the first and second sets of values.

The first set of values and/or the second sets of values may be transmitted in any suitable signaling, for example, broadcast in system information block (SIB), or in a dedicated signaling (such as a RRC message). If both the first and second sets of values are transmitted to the first device 110, they may be transmitted separately, or transmitted together, e.g., in the same signaling.

In some example embodiments, the act 205 may be omitted and the second device 120 may transmit, to the first device 110, at least one of the first and second sets of values for the parameter set. For example, for a cell with the capability of the enhanced duplex operation, the second device 120 may transmit to the first device 110 at least the second set of values, and for a cell without that capability, the second device 120 may transmit to the first device 110 the first set of values. For another example, in a deployment scenario where all the cells have the SBFD capability, a determination of the capability of the cell may be unnecessary. In a further example, for the purpose of cell selection, for a cell of the second device 120 with the capability of the enhanced duplex operation, the second device 120 may at least transmit the second set of values without a determination of its capability. This is because the second device 120 knows its own cell's capability a priori.

In some example embodiments, as compared to the first set of values, the second set of values may result in a different possibility to determine the cell as a target cell. In this way, the behaviors of the ED aware devices and legacy devices can be differentiated. Further, in some example embodiments, as compared to the first set of values, the second set of values may result in a higher possibility to determine the cell as a target cell. In this way, the ED aware devices can be facilitated to camp on or access an ED cell, and/or the legacy devices can be prevented or discouraged to camp on or access an ED cell.

In some example embodiments, the parameter set associated with the process towards the cell may comprise one or more parameters specific to the cell. In some example embodiments, the parameter set may comprise parameters for a group of cells including the cell. For example, the parameter set may comprise priorities for reselecting a target cell from the group of cells including the cell.

The one or more parameters included in the parameter set may depend on the process towards the cell. In some example embodiments, the process towards the cell may comprise a cell selection process towards the cell. The parameter set may include one or more parameters (e.g., one or more offsets) associated with the cell selection process. Alternatively, or in addition, the process towards the cell may comprise a cell reselection process towards the cell. The parameter set may include one or more parameters (e.g., one or more offsets, priorities) associated with the cell reselection process. Alternatively, or in addition, the process towards the cell may comprise a handover process towards the cell. It is to be understood that the cell selection and cell reselection are typically performed by the first device 110 while the handover process may be triggered by the second device 120.

Example parameters of the parameter set will be described in detail below.

In some example embodiments, the first device 110 may receive 215 the first set of values for the parameter set from the second device 120. Alternatively, or in addition, the first device 110 may receive 225 the second set of values for the parameter set from the second device 120. For example, if the first device 110 is a legacy device or if the cell is a legacy cell, the first set of values is received without the second set of values. For another example, if the cell is an ED cell, at least the second set of values is received by the first device 110.

Then, in some example embodiments, the first device 110 may determine 230 whether a condition associated with the enhanced duplex operation is met. As an example, the condition may include that the second set of values for the parameter set is received. Alternatively, or in addition, the condition may include that the first device 110 supports the enhanced duplex operation, or in other words, the first device 110 is the ED aware device. For example, if the first device 110 indicates support of the enhanced duplex operation in a capability information message, it may be determined that the first device 110 supports the enhanced duplex operation.

Alternatively, or in addition, the condition may include that the cell is known to the first device 110 to have the capability of the enhanced duplex operation. For example, if the second device 120 transmits to the first device 110 an indication that the cell is capable of the enhanced duplex operation, it may be determined that the cell is known to the first device 110 to have the capability of the enhanced duplex operation.

It is to be understood that the above examples of the condition are given for the purpose of illustration without any limitation. In example embodiments of the present disclosure, any suitable condition associated with the enhanced duplex operation may be implemented.

If the condition is not met, the first device 110 may apply the first set of values to the process towards the cell. For example, if the first device 110 is the legacy device, or if the cell is the legacy cell, the first set of values may be applied to the process towards to the cell.

If the condition is met, the first device 110 may at least apply 235 the second set of values to the process towards to cell. For example, if the first device 110 is the ED aware device and the cell is the ED cell, at least the second set of values may be applied to the process towards the cell. In some example embodiments, the second set of values may be used without the first set of values. In other words, the second set of values replaces the first set of values. Alternatively, in some example embodiments, the second set of values may be used in combination with the first set of values. For example, if the parameter set includes an offset, a final offset for an ED cell is determined based on a first offset value in the first set and a second offset value in the second set. Such example embodiments will be described in detail below.

It is to be understood that in some example embodiments, check of the condition at 230 may be omitted. For example, if the first device 110 can receive the second set of values, it may not check the condition. For another example, if the first device 110 is the ED aware device, it may not be required to check the condition. In such example embodiments, the first device 110 may at least apply the received second set of values to the process towards the cell.

Example interactions between the first device 110 and the second device 120 are described above with reference to FIG. 2. Through the use of an additional set of parameter values, legacy devices and ED aware devices can be efficiently controlled for ED cell selection, ED cell reselection, or ED cell handover.

Some example parameters in the parameter set are now described.

In some example embodiments, the parameter set may include an offset to a minimum required signal received level of a received signal, which is also referred to as “received level offset”. Alternatively, or in addition, the parameter set may include an offset to a minimum required signal quality level of a received signal, which is also referred to as “quality level offset”. The received level offset and quality level offset may be configured per cell or per frequency.

Cell selection or cell reselection may be performed when the corresponding cell selection criterion S or cell reselection criterion S is fulfilled:

Srxlev>0 and Squal>0 (1 )

where:

Srxlev=Qᵣₓₗₑᵥₘₑₐₛ−(Qᵣₓₗₑᵥₘᵢₙ+Q_{rxlevminoffset})−P_{compensation}−Qoffsetₜₑₘₚ (2)

Squal=Q_{qualmeas}−(Q_{qualmin}+Q_{qualminoffset})−Qoffsetₜₑₘₚ (3)

The received level offset may be the parameter “Q_{xlevminoffset}” in equation (2) and the quality level offset may be the parameter “Q_{qualminoffset}” in equation (3). In some example embodiments, in the first set of values, the second device 120 may increase the first offset values for the parameters “Q_{rxlevminoffset}” and “Q_{qualminoffset}” associated with an ED cell to prevent the legacy device from selecting the ED cell as a target cell. In this way, the cell selection or cell reselection criterion is made hard to fulfill for the legacy device and the legacy device will deprioritize to select or reselect towards the ED cell.

Meanwhile, in the second set of values, the second device 120 may configure second offset values for the parameters “Q_{rxlevminoffset}” and “Q_{qualminoffset}” associated with the ED cell to facilitate the ED aware device to select the ED cell or reselect towards the ED cell. The second offset values for parameters “Q_{rxlevminoffset}” and “Q_{qualminoffset}” may be represented by Q_{rxlevminoffsetED} and Q_{qualminoffsetED}. Accordingly, when the ED aware device performs cell selection or cell reselection towards the ED cell, “Srxlev” and “Squal” in equation (1) may be derived as:

Srxlev=Qᵣₓₗₑᵥₘₑₐₛ−(Qᵣₓₗₑᵥₘᵢₙ+Q_{rxlevminoffsetED})−P_{compensation}−Qoffsetₜₑₘₚ (4)

Squal=Q_{qualmeas}−(Q_{qualmin}+Q_{qualminoffsetED})−Qoffsetₜₑₘₚ (5)

The first offset value for the received level offset is different from (for example, higher than) the second offset value for the received level offset. Similarly, the first offset value for the quality level offset is different from (for example, higher than) the second offset value for the quality level.

In some example embodiments, the second offset values may be used to determine the criterion S in place of the first offset values. In some example embodiments, both the second offset values and the first offset values may be used to determine the criterion S. For example, for the ED cell, the ED aware device may first determine an initial value of the criterion S by applying the first offset values in the first set and add or subtract the second offset values to the initial value of the criterion S to get the final value of the criterion S.

In some example embodiments, the second offset value may be ED cell specific, or in other words, each ED cell is configured with the second offset value. Alternatively, in some example embodiments, the second offset value may be common to all ED cells. The second device 120 may configure a common offset value or a group of common offset values to all ED cells. The second device 120 may transmit to the first device 110 an indication of which cell is an ED cell. Therefore, the first device 110 can apply the common offset value or the group of common offset values to determine the criterion S for an ED cell.

The second offset values may be transmitted in any suitable signaling. For example, the second offset values associated with a cell selection process may be transmitted in SIB1. The second offset values associated with an intra-frequency cell reselection process may be transmitted in SIB3. The offset values associated with an inter-frequency cell reselection process may be transmitted in SIB4. However, these are given as examples without any limitation to the protection scope.

In some example embodiments, the parameter set may include a minimum required signal received level of a received signal, for example Qᵣₓₗₑᵥₘᵢₙ as shown in equation (2). Alternatively, or in addition, the parameter set may include a minimum required signal quality level of a received signal, for example Q_{qualmin} as shown in equation (3). The minimum required signal received level and the minimum required signal quality level may be configured per cell or per frequency.

Similar to the received level offset and the received quality offset, in some example embodiments, first values for these levels in the first set may be larger than second values for these levels in the second set, so as to prevent the legacy device from determining the ED cell as the target cell and/or to facilitate the ED aware device to determine the ED cell as the target cell.

In some example embodiments, the parameter set may include a priority for selecting a serving cell, or in other words, a priority for cell selection or a priority for selecting the cell as a serving cell. For example, the ED cell may have a relative low priority in the first set, and/or the ED cell may have a relative high priority in the second set.

Alternatively, or in addition, in some example embodiments, the parameter set may include priorities for reselecting a target cell from a group of cells, or in other words, priorities for cell reselection. For example, in the first set, the parameter CellReselectionPriority which denotes the priority for the ED cell to be used by the legacy device may be set to a low value. Meanwhile, in the second set, the parameter CellReselectionPriority-ED which denotes the priority for the ED cell to be used by the ED aware device may be set to a higher value. As such, the legacy device is discouraged to reselect towards the ED cell and/or the ED aware device is facilitated to reselect towards the ED cell.

In such example embodiments, the second device 120 can configure a low priority for ED frequency or cell and thus the legacy devices will not camp on that frequency or cell unless there is no other frequency or cell to camp on. But for the ED aware devices, the second device 120 can configure different priorities that would allow more prioritized camping on the ED frequency or cell.

As an example use case, after selecting or reselecting to a cell on a frequency layer according to the priority value “CellReselectionPriority-ED-rXX” in the second set, the first device 110 may acquire the target cell system information and find out the cell does not support ED operation. The ED capability may be signalled by the cell in system information. The first device 110 may be required to perform cell selection or reselection once again by applying offsets to the corresponding cell. These offsets (for example, denoted by q-RxLevMinOffset-noEDCell-rXX and q-QualMinOffset-noEDCell-rXX)) could be signalled together with “CellReselectionPriority-ED-rXX”.

In some example embodiments, the parameter set may include a first list of neighbouring cells available for cell reselection. The first device 110 may use the cells in the first list during the cell reselection process. For example, the first list may be the intraFreqAllowedCellList and/or interFreqAllowedCellList. The first set of values may comprise a first version of the first list, which may include the legacy cells. The second set of values may comprise a second version of the first list, which may include the ED cells.

Alternatively, or in addition, the parameter set may include a second list of neighbouring cells unavailable for cell reselection. The first device 110 will not use the cells in the second list during the cell reselection process. For example, the second list may be intraFreqExcludedCellList and/or interFreqExcludedCellList. The first set of values may comprise a first version of the second list, which may include the ED cells. The second set of values may comprise a second version of the second list, which may include the legacy cells or may be empty.

In some example embodiments, the parameter set may include a frequency specific offset to a quality measurement for reselecting a target cell from a group of cells including the cell. For example, this offset may be Qoffset_{frequency}, which is a frequency specific offset for equal priority frequencies. The first set of values associated with the ED cell may include a first value for the frequency specific offset, while the second set of values associated with the ED cell may include a second value for the frequency specific offset. The second value may be different from the first value.

Some parameters are described above. However, it is to be understood that these parameters are given as examples without any limitation to the protection scope. Other parameters may be possible. For example, the parameter set may include an offset to the level of the received signal (Rx level). For another example, the parameter set may include an offset to the quality level of the received signal (Rx quality).

The values for the parameter set may be transmitted in any suitable signaling. For example, the offset values to be used for the cell selection may be transmitted in SIB1. The offset values to be used for intra-frequency cell reselection may be transmitted in SIB3, and the offset values to be used for inter-frequency cell reselection may be transmitted in SIB4. As another example, the priority values for cell or frequency reselection may be transmitted in an RRCRelease message, the priority values for intra-frequency cell reselection may be transmitted in SIB2, and the priority values to be used for inter-frequency cell reselection may be transmitted in SIB4. It is to be understood that the above signaling is given as examples without any limitation to the protection scope. Any other suitable signaling may be possible.

In the above example embodiments, the first set of values is configured to make it harder for the legacy devices to determine the ED cell as a target cell, while the second set of values is configured to make it easier for the ED aware devices to determine the ED cell as a target cell. It is to be understood that alternatives may be possible as long as these two sets of values can differentiate the behaviors of the legacy devices and the ED aware devices. For example, the first set of values may be configured to make it easier for the legacy devices to determine the legacy cell as a target cell, while the second set of values may be configured to make it harder for the ED aware devices to determine the legacy cell as a target cell. In such an example, the first device 110 may apply the second set of values to a process towards a legacy cell. Accordingly, the condition checked at 230 may include that the cell is known to be a legacy cell and the first device 110 supports the ED operation.

Some example embodiments are meant for a network for mobile communications. In such a network, a subset of terminal devices (UEs) is prepared for the feature. Also a subset of network devices (base stations) supports the feature. In some example embodiments, the feature relates to an enhanced duplex operation, e.g. SBFD (sub-band non-overlapping full duplex) or flexible duplexing (cross-division duplexing) or flexible TDD or dynamic TDD (where, in some geographical region, the TDD rhythm need not be the same for all cells on the same frequency or in the same operating band).

For at least a subset of cells, there are at least 2 different sets of values for a parameter set which is e.g. associated with a process towards a cell. In the other cells, there may be just one set of values. The process towards a cell may refer to cell selection, cell reselection and/or handover. Thus, in an example embodiment, the parameters relate to cell selection, cell reselection and/or handover. The network device signals these values. UEs that are not prepared for the feature (legacy UEs) apply a first set of values. UEs that are prepared for the feature (e.g. ED aware UEs) apply a second set of values for a cell from the subset of cells, and they apply the first set of values for the other cells. (A set in this context contains at least 1 value.) For the case of cell selection, the set or sets of values refer(s) to the cell which signals the values. For the case of cell reselection and/or handover, the set or sets of values refer(s), at least partly, to one or more neighbouring cells of the cell which signals the values. Signalling may be performed e.g. by transmitting in a SIB or by broadcasting it.

The first set of values is used by UEs that are not prepared for the feature. The first set of values may be configured to make, at comparable RX conditions, selecting a cell not supporting the feature (legacy cell) more likely than selecting a cell supporting the feature (e.g. ED cell). This configuration targets at UEs that are not prepared for the feature. They shall preferably select cells not supporting the feature.

The second set of values may be configured to make, at comparable RX conditions, selecting a cell supporting the feature at least as likely as selecting a cell not supporting the feature. This configuration targets at UEs that are prepared for the feature. UEs that are not prepared for the feature may be unable to process the second set of values.

Example where the subset of cells consists of the cells supporting the feature: The first set of values contains unfavorable values for the cells supporting the feature, i.e. making the selection of or the reselection/handover to a cell supporting the feature rather unlikely if there is also a suitable cell not supporting the feature that the UE can connect to. The second set of values is for UEs that are prepared for the feature. It makes these UEs apply normal (neutral) or rather favorable values for the cells supporting the feature. This means that the second set of values applies to the combination of UEs that are prepared for the feature with cells that support the feature.

Example where the subset of cells consists of the cells not supporting the feature: The first set of values contains favorable values for the cells not supporting the feature, i.e. making the selection of or the reselection/handover to a cell not supporting the feature rather likely if there is a suitable cell not supporting the feature that the UE can connect to. The second set of values is for UEs that are prepared for the feature. It makes these UEs apply normal (neutral) or rather unfavorable values for the cells not supporting the feature. This means that the second set of values applies to the combination of UEs that are prepared for the feature with cells that do not support the feature.

The first set of values may anyway be signaled because legacy UEs need it. There are several ways to make UEs that are prepared for the feature apply a second set of values for a cell. Examples include:

For a cell for which UEs that are prepared for the feature shall apply a second set of values, a second set of value is transmitted, e.g. in a system information block (SIB). The UE that is prepared for the feature checks if a second set of values is signaled for the cell. If so, the UE receives and/or applies at least the second set of values for the cell. At least if the second set of values is not signaled for a cell, the UE receives and/or applies a first set of values for the cell.

In another example, the UE receives an indication that a cell supports the feature or an indication that a cell does not support the feature or an indication about which set of values to use for a cell. The second set of values may be received separately. This is particularly efficient if the second set of values is the same for the subset of cells. The second set of values may apply in combination with the first set of values.

For neighbouring cells supporting the feature or for neighbouring cells not supporting the feature, a base station of the network signals at least two sets of values (where each set has at least one element, i.e. one value or parameter) that influence the UEs' cell reselection and/or handover—at least one set for UEs not supporting the feature and another set for UEs supporting the feature.

A set of values may refer to a cell or a frequency layer. (This property can be different for different sets.)

One set of values may apply relative to another set of values. For example, for a neighbouring cell supporting the feature, the set of values for UEs supporting the feature may apply relative (in particular as an offset) to the set of values for UEs not supporting the feature.

The base station signals which of the neighbouring cells support the feature or to which neighbouring cells a set of values for UEs supporting the feature applies.

Example: The legacy signalling of RX level and/or RX quality criteria is configured to make it difficult for legacy UEs to reselect to a ED cell. An offset is signalled that applies, to ED aware UEs, in addition to cell-specific values in the first set of values, in all ED cells (or in all ED cells in a neighbouring cell list). This offset makes it easier for ED aware UEs to select ED cells. Since this offset is the same for all base stations in the entire list of neighbouring cells, there is no need to signal a separate set of values for each and every neighbouring ED cell—one common set of values (in particular offset values) for all ED cells is enough. This set of values may not replace, but complement the set of values for legacy UEs.

There is a base station which serves a cell of a network for mobile communications and which supports a feature that a subset of UEs support.

A base station signals at least two sets of values (where each set has at least one element, e.g. one parameter) that influence the UEs' cell selection—at least one set for UEs not supporting the feature and another set for UEs supporting the feature. The feature may involve simultaneous UL and DL in TDD bands, in particular SBFD.

To a UE not supporting the feature or making an emergency call or satisfying both conditions, the base station allocates UL radio resources without simultaneous DL.

To a UE not supporting the feature or making an emergency call or satisfying both conditions, the base station allocates DL radio resources without simultaneous UL.

The at least two sets of values result in tighter conditions for the ED cell being selected as serving cell for UEs not supporting the feature than for UEs supporting the feature.

Examples of tighter conditions are:
The cell is effectively barred.
Only emergency calls are allowed.
The base station is a part of a network with base stations supporting the feature and base stations not supporting the feature. Compared with a cell not supporting the feature, a less favourable offset (making the selection of the cell as serving cell less likely) is applied in the cell of the base station supporting the feature to an RX level and/or RX quality related criterion (where no offset can be considered as an offset of 0 or 0 dB).

When a UE is commanded to make a handover, the selection of a target cell depends on the UE's and on target cell candidates' support of the feature.

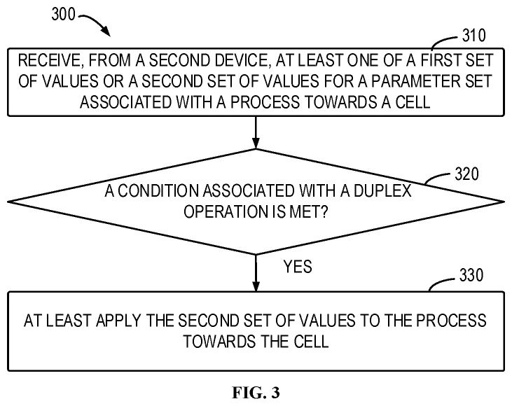

FIG. 3 shows a flowchart of an example method 300 implemented at a first device in accordance with some example embodiments of the present disclosure. For the purpose of discussion, the method 300 will be described from the perspective of the first device 110 in FIG. 1.

At block 310, the first device 110 receives, from a second device 120, at least one of a first set of values or a second set of values for a parameter set associated with a process towards a cell. At block 320, the first device 110 determines whether a condition associated with a duplex operation is met. If the condition is met, the method 300 proceeds to block 330. At block 330, the first device 110 at least applies the second set of values to the process towards the cell.

In some example embodiments, if the condition is not met, the first device 110 applies the first set of values to the process towards the cell.

In some example embodiments, as compared to the first set of values, the second set of values may result in a different possibility to determine the cell as a target cell.

In some example embodiments, as compared to the first set of values, the second set of values may result in a higher possibility to determine the cell as a target cell.

In some example embodiments, the parameter set may comprise at least one of: an offset to a minimum required signal received level, an offset to a minimum required signal quality level, a minimum required signal received level, a minimum required signal quality level, a priority for selecting a serving cell, priorities for reselecting a target cell from a group of cells including the cell, a first list of neighbouring cells available for cell reselection, or a second list of neighbouring cells unavailable for cell reselection, or a frequency specific offset to a quality measurement for reselecting a target cell from a group of cells including the cell.

In some example embodiments, the process may comprise at least one of: a cell selection process, a cell reselection process, or a cell handover process.

In some example embodiments, at least applying the second set of values may comprise: determining, from the first set of values, a first offset value for an offset in the parameter set; determining, from the second set of values, a second offset value for the offset; and determining a value of a criterion for determining the cell as a target cell based on the first and second offset values.

In some example embodiments, the condition may comprise at least one of: that the second set of values for the parameter set is received, that the first device 110 supports the duplex operation, or that the cell is known to the first device 110 to have a capability of the duplex operation.

In some example embodiments, the at least one of the first or the second set of values may be received in a system information block.

In some example embodiments, the duplex operation comprises a sub-band non-overlapping full-duplex operation.

In some example embodiments, the first device 110 may comprise a terminal device and the second device 120 may comprise a network device.

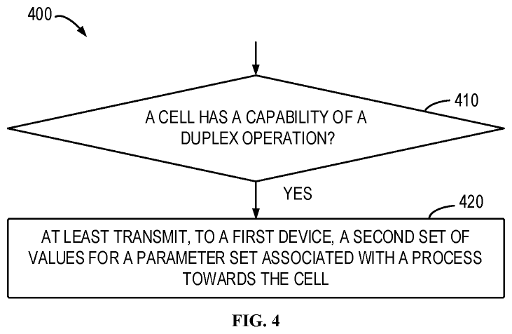

FIG. 4 shows a flowchart of an example method 400 implemented at a second device in accordance with some example embodiments of the present disclosure. For the purpose of discussion, the method 400 will be described from the perspective of the second device 120 in FIG. 1.

At block 410, the second device 120 determines whether a cell has a capability of a duplex operation. If the cell has the capability of the duplex operation, the method 400 proceeds to block 420. At block 420, the second device 120 at least transmits, to a first device 110, a second set of values for a parameter set associated with a process towards the cell.

In some example embodiments, if the cell does not have the capability of the duplex operation, the second device 120 transmits a first set of values for the parameter set without the second set of values.

In some example embodiments, as compared to the first set of values, the second set of values may result in a different possibility to determine the cell as a target cell.

In some example embodiments, as compared to the first set of values, the second set of values may result in a higher possibility to determine the cell as a target cell.

In some example embodiments, the parameter set may comprise at least one of: an offset to a minimum required signal received level, an offset to a minimum required signal quality level, a minimum required signal received level, a minimum required signal quality level, a priority for selecting a serving cell, priorities for reselecting a target cell from a group of cells including the cell, a first list of neighbouring cells available for cell reselection, a second list of neighbouring cells unavailable for cell reselection, or a frequency specific offset to a quality measurement for reselecting a target cell from a group of cells including the cell.

In some example embodiments, the process may comprise at least one of: a cell selection process, a cell reselection process, or a cell handover process.

In some example embodiments, the at least one of the first or the second set of values may be broadcasted in a system information block.

In some example embodiments, the duplex operation comprises a sub-band non-overlapping full-duplex operation.

In some example embodiments, the first device 110 may comprise a terminal device and the second device 120 may comprise a network device.

In some example embodiments, a first apparatus capable of performing any of the method 300 (for example, the first device 110 in FIG. 1) may comprise means for performing the respective operations of the method 300. The means may be implemented in any suitable form. For example, the means may be implemented in a circuitry or software module. The first apparatus may be implemented as or included in the first device 110 in FIG. 1.

In some example embodiments, the first apparatus comprises means for receiving, from a second apparatus, at least one of a first set of values or a second set of values for a parameter set associated with a process towards a cell; means for determining whether a condition associated with a duplex operation is met; and means for in accordance with a determination that the condition is met, at least applying the second set of values to the process towards the cell.

In some example embodiments, the first apparatus further comprises: means for in accordance with a determination that the condition is not met, applying the first set of values to the process towards the cell.

In some example embodiments, as compared to the first set of values, the second set of values results in a different possibility to determine the cell as a target cell.

In some example embodiments, as compared to the first set of values, the second set of values results in a higher possibility to determine the cell as a target cell.

In some example embodiments, the parameter set comprises at least one of: an offset to a minimum required signal received level, an offset to a minimum required signal quality level, a minimum required signal received level, a minimum required signal quality level, a priority for selecting a serving cell, priorities for reselecting a target cell from a group of cells including the cell, a first list of neighbouring cells available for cell reselection, or a second list of neighbouring cells unavailable for cell reselection, or a frequency specific offset to a quality measurement for reselecting a target cell from a group of cells including the cell.

In some example embodiments, the process comprises at least one of: a cell selection process, a cell reselection process, or a cell handover process.

In some example embodiments, means for at least applying the second set of values comprises: means for determining, from the first set of values, a first offset value for an offset in the parameter set; means for determining, from the second set of values, a second offset value for the offset; and means for determining a value of a criterion for determining the cell as a target cell based on the first and second offset values.

In some example embodiments, the condition comprises at least one of: that the second set of values for the parameter set is received, that the first apparatus supports the duplex operation, or that the cell is known to the first apparatus to have a capability of the duplex operation.

In some example embodiments, the at least one of the first or the second set of values may be received in a system information block.

In some example embodiments, the duplex operation comprises a sub-band non-overlapping full-duplex operation.

In some example embodiments, the first apparatus comprises a terminal apparatus and the second apparatus comprises a network apparatus.

In some example embodiments, the first apparatus further comprises means for performing other operations in some example embodiments of the method 800 or the first apparatus 110. In some example embodiments, the means comprises at least one processor; and at least one memory storing instructions that, when executed by the at least one processor, cause the performance of the first apparatus.

In some example embodiments, a second apparatus capable of performing any of the method 400 (for example, the second device 120) may comprise means for performing the respective operations of the method 400. The means may be implemented in any suitable form. For example, the means may be implemented in a circuitry or software module. The second apparatus may be implemented as or included in the second device 120 in FIG. 1.

In some example embodiments, the second apparatus comprises means for determining whether a cell has a capability of a duplex operation; and means for, in accordance with a determination that the cell has the capability of the duplex operation, at least transmitting, to a first apparatus, a second set of values for a parameter set associated with a process towards the cell.

In some example embodiments, the second apparatus further comprises: means for in accordance with a determination that the cell does not have the capability of the duplex operation, transmitting a first set of values for the parameter set without the second set of values.

In some example embodiments, as compared to the first set of values, the second set of values results in a different possibility to determine the cell as a target cell.

In some example embodiments, as compared to the first set of values, the second set of values results in a higher possibility to determine the cell as a target cell.

In some example embodiments, the parameter set comprises at least one of: an offset to a minimum required signal received level, an offset to a minimum required signal quality level, a minimum required signal received level, a minimum required signal quality level, a priority for selecting a serving cell, priorities for reselecting a target cell from a group of cells including the cell, a first list of neighbouring cells available for cell reselection, a second list of neighbouring cells unavailable for cell reselection, or a frequency specific offset to a quality measurement for reselecting a target cell from a group of cells including the cell.

In some example embodiments, the process comprises at least one of: a cell selection process, a cell reselection process, or a cell handover process.

In some example embodiments, the at least one of the first or the second set of values may be broadcasted in a system information block.

In some example embodiments, the duplex operation comprises a sub-band non-overlapping full-duplex operation.

In some example embodiments, the first apparatus comprises a terminal apparatus and the second apparatus comprises a network apparatus.

In some example embodiments, the second apparatus further comprises means for performing other operations in some example embodiments of the method 400 or the second device 120. In some example embodiments, the means comprises at least one processor; and at least one memory storing instructions that, when executed by the at least one processor, cause the performance of the second apparatus.

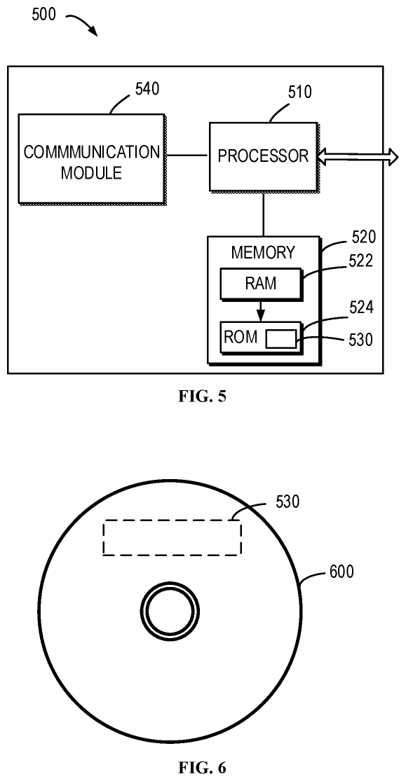

FIG. 5 is a simplified block diagram of a device 500 that is suitable for implementing example embodiments of the present disclosure. The device 500 may be provided to implement a communication device, for example, the first device 110 or the second device 120 as shown in FIG. 1. As shown, the device 500 includes one or more processors 510, one or more memories 520 coupled to the processor 510, and one or more communication modules 540 coupled to the processor 510.

The communication module 540 is for bidirectional communications. The communication module 540 has one or more communication interfaces to facilitate communication with one or more other modules or devices. The communication interfaces may represent any interface that is necessary for communication with other network elements. In some example embodiments, the communication module 540 may include at least one antenna.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The instructions of the program 530 may include instructions for performing operations/acts of some example embodiments of the present disclosure. The program 530 may be stored in the memory, e.g., the ROM 524. The processor 510 may perform any suitable actions and processing by loading the program 530 into the RAM 522.

The example embodiments of the present disclosure may be implemented by means of the program 530 so that the device 500 may perform any process of the disclosure as discussed with reference to FIG. 2 to FIG. 4. The example embodiments of the present disclosure may also be implemented by hardware or by a combination of software and hardware.

In some example embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 6 shows an example of the computer readable medium 600 which may be in form of CD, DVD or other optical storage disk. The computer readable medium 600 has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provides at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device comprising:
at least one processor; and
at least one memory storing instructions that, when executed by the at least one processor, cause the first device at least to perform:
receiving, from a second device, at least one of a first set of values or a second set of values for a parameter set associated with a process towards a cell;
determining whether a condition associated with a duplex operation is met; and
in accordance with a determination that the condition is met, at least applying the second set of values to the process towards the cell.

2. The first device of claim 1, wherein the first device is further caused to perform:
in accordance with a determination that the condition is not met, applying the first set of values to the process towards the cell.

3. The first device of claim 1, wherein as compared to the first set of values, the second set of values results in a different possibility to determine the cell as a target cell.

4. The first device of claim 3, wherein as compared to the first set of values, the second set of values results in a higher possibility to determine the cell as a target cell.

5. The first device of claim 1, wherein the parameter set comprises at least one of:
an offset to a minimum required signal received level,
an offset to a minimum required signal quality level,
a minimum required signal received level,
a minimum required signal quality level,
a priority for selecting a serving cell,
priorities for reselecting a target cell from a group of cells including the cell,
a first list of neighbouring cells available for cell reselection, or
a second list of neighbouring cells unavailable for cell reselection, or
a frequency specific offset to a quality measurement for reselecting a target cell from a group of cells including the cell.

6. The first device of claim 1, wherein the process comprises at least one of:
a cell selection process,
a cell reselection process, or
a cell handover process.

7. The first device of claim 1, wherein at least applying the second set of values comprises:
determining, from the first set of values, a first offset value for an offset in the parameter set;
determining, from the second set of values, a second offset value for the offset; and
determining a value of a criterion for determining the cell as a target cell based on the first and second offset values.

8. The first device of claim 1, wherein the condition comprises at least one of:
that the second set of values for the parameter set is received,
that the first device supports the duplex operation, or
that the cell is known to the first device to have a capability of the duplex operation.

9. The first device of claim 1, wherein the at least one of the first or the second set of values is received in a system information block.

10. The first device of claim 1, wherein the duplex operation comprises a sub-band non-overlapping full-duplex operation.

11. The first device of claim 1, wherein the first device comprises a terminal device and the second device comprises a network device.

12. A second device comprising:
at least one processor; and
at least one memory storing instructions that, when executed by the at least one processor, cause the second device at least to perform:
determining whether a cell has a capability of a duplex operation; and
in accordance with a determination that the cell has the capability of the duplex operation, at least transmitting, to a first device, a second set of values for a parameter set associated with a process towards the cell.

13. The second device of claim 12, wherein the second device is further caused to perform:
in accordance with a determination that the cell does not have the capability of the duplex operation, transmitting a first set of values for the parameter set without the second set of values.

14. The second device of claim 12, wherein as compared to the first set of values, the second set of values results in a different possibility to determine the cell as a target cell.

15. The second device of claim 14, wherein as compared to the first set of values, the second set of values results in a higher possibility to determine the cell as a target cell.

16. The second device of claim 12, wherein the parameter set comprises at least one of:
an offset to a minimum required signal received level,
an offset to a minimum required signal quality level,
a minimum required signal received level,
a minimum required signal quality level,
a priority for selecting a serving cell,
priorities for reselecting a target cell from a group of cells including the cell,
a first list of neighbouring cells available for cell reselection,
a second list of neighbouring cells unavailable for cell reselection, or
a frequency specific offset to a quality measurement for reselecting a target cell from a group of cells including the cell.

17. The second device of claim 12, wherein the process comprises at least one of:
a cell selection process,
a cell reselection process, or
a cell handover process.

18. The second device of claim 12, wherein the at least one of the first or the second set of values is broadcasted in a system information block.

19. The second device of claim 12, wherein the duplex operation comprises a sub-band non-overlapping full-duplex operation.

20. (canceled)

21. A method comprising:
receiving, at a first device from a second device, at least one of a first set of values and a second set of values for a parameter set associated with a process towards a cell;
determining whether a condition associated with a duplex operation is met; and
in accordance with a determination that the condition is met, at least applying the second set of values to the process towards the cell.

22-25. (canceled)
